(19) United States
(12) Patent Application Publication
(10) Pub. No.: US 2026/0302093 A1
(43) Pub. Date: Oct. 1, 2026

(54) MANUFACTURING METHOD OF SUPERCAPACITOR ELECTRODE MATERIAL AND SUPERCAPACITOR ELECTRODE USING THE SAME

(71) Applicant: CPC CORPORATION, TAIWAN, Kaohsiung City (TW)

(72) Inventors: Cheng-Wei HUANG, Kaohsiung City (TW); Tzu-Hsien HSIEH, Kaohsiung City (TW); Yu-Hsien LIAO, Kaohsiung City (TW); Yang-Chuang CHANG, Kaohsiung City (TW)

(73) Assignee: CPC CORPORATION, TAIWAN, Kaohsiung City (TW)

(21) Appl. No.: 19/190,908

(22) Filed: Apr. 28, 2025

(30) Foreign Application Priority Data
Mar. 25, 2025 (TW) 114111240

(51) Int. Cl. H01G 11/32; C01B 32/05; H01G 11/86

(52) U.S. Cl. CPC H01G 11/32; C01B 32/05; H01G 11/86; C01P 2006/40

(57) ABSTRACT

Disclosed is a manufacturing method of a supercapacitor electrode material, comprising a material preparation step of mixing sodium lignosulfonate, a surfactant and an activator to obtain a biomass material; a heat treatment step of performing on the biomass material a heat treatment at 300° C. for 1 hour in an oxygen-free atmosphere, followed by a heat treatment at 900° C. for 8 hours in an oxygen-free atmosphere to obtain a carbonized material; and a washing step of acid washing the carbonized material with hydrochloric acid to adjust pH to 0.5, followed by water washing to adjust the pH to above 6, thereby obtaining a biomass porous carbon material as the supercapacitor electrode material.

### FIELD OF THE INVENTION

The present invention relates to a supercapacitor electrode material and more particularly relates to a manufacturing method of a supercapacitor electrode material and a supercapacitor electrode using the same.

### BACKGROUND OF THE INVENTION

Supercapacitor electrodes are required to exhibit excellent electrical conductivity, high thermal stability, long-term chemical inertness and stability, corrosion resistance, and high surface area per unit volume and mass. Additional requirements include environmental compatibility and low manufacturing cost. The amount of charge stored per unit voltage in a supercapacitor is generally proportional to the surface area of the electrode. Accordingly, activated carbon, owing to its high specific surface area, has received considerable attention as a promising electrode material for supercapacitors.

Therefore, the cost of activated carbon is directly related to the manufacturing cost of supercapacitors. If the cost of activated carbon can be effectively suppressed, the price of supercapacitor products can be reduced, thereby facilitating their widespread adoption and commercialization.

### SUMMARY OF THE INVENTION

Therefore, one objective of present invention is to provide a manufacturing method of a supercapacitor electrode material, wherein sodium lignosulfonate, a by-product generated from the pulp production process, is utilized to produce a biomass porous carbon material, thereby reducing the cost of supercapacitor electrodes and enhancing the economic value of biomass waste in alignment with the principles of circular economy.

In order to overcome the technical problems in prior art, the present invention provides a manufacturing method of a supercapacitor electrode material, comprising a material preparation step of mixing sodium lignosulfonate, a surfactant and an activator to obtain a biomass material; a heat treatment step of performing on the biomass material a heat treatment at 300° C. for 1 hour in an oxygen-free atmosphere, followed by a heat treatment at 900° C. for 8 hours in an oxygen-free atmosphere to obtain a carbonized material; and a washing step of acid washing the carbonized material with hydrochloric acid to adjust pH to 0.5, followed by water washing to adjust the pH to above 6, thereby obtaining a biomass porous carbon material as the supercapacitor electrode material.

In one embodiment of the present invention, the manufacturing method is provided further comprising, before the washing step, a crushing step of crushing the carbonized material.

In one embodiment of the present invention, the manufacturing method is provided further comprising, after the washing step, a second heat treatment step of performing on the biomass mixture a heat treatment at 300° C. for 1 hour in an oxygen-free atmosphere, followed by a heat treatment at 900° C. for 8 hours in an oxygen-free atmosphere.

In one embodiment of the present invention, the manufacturing method is provided, wherein in the material preparation step, the weight of the activator accounts for 1 to 15% of the weight of the sodium ligninsulfonate.

In one embodiment of the present invention, the manufacturing method is provided, wherein in the raw-material preparation step, the weight of the surfactant accounts for 50 to 200% of the total weight of the sodium ligninsulfonate and the activator.

In another embodiment of the present invention, a supercapacitor electrode is provided, wherein: as an active material of the super capacitor electrode, the biomass porous carbon material prepared by the manufacturing method described above is used, as a conductive agent of the super capacitor electrode, at least one selected from the group consisting of carbon black, graphite, graphene, carbon nanotubes and carbon nanofibers is used, and as an adhesive of the supercapacitor electrode, at least one selected from the group consisting of methyl methacrylate, carboxymethyl cellulose, styrene-butadiene rubber and polyvinylidene fluoride is used.

In another embodiment of the present invention, the supercapacitor electrode is provided, wherein the weight of the conductive agent accounts for 1 to 10% of the weight of the active material.

In another embodiment of the present invention, the supercapacitor electrode is provided, wherein the weight of the adhesive accounts for 1 to 10% of the weight of the active material.

By means of the technical means adopted by the manufacturing method of the supercapacitor electrode material of the present invention, commercial-grade biomass porous carbon material can be produced from sodium lignosulfonate, a by-product generated from the pulping process, for use in fabricating supercapacitor electrodes, thereby reducing the cost of supercapacitor electrodes, enhancing the economic value of biomass waste, and achieving the trend of circular economy.

### BRIEF DESCRIPTION OF THE DRAWINGS

FIG. 1 is a flowchart illustrating a manufacturing method of a supercapacitor electrode material according to one embodiment of the present invention.

FIG. 2(a) is a graph showing the nitrogen adsorption-desorption analysis results of the biomass porous carbon material produced by the manufacturing method of the supercapacitor electrode material according to one embodiment of the present invention.

FIG. 2(b) is a graph showing the pore structure analysis results of the biomass porous carbon material produced by the manufacturing method of the supercapacitor electrode material according to one embodiment of the present invention.

FIGS. 3(a), 3(b), and 3(c) are graphs showing the electrochemical test analysis results of the biomass porous carbon material produced by the manufacturing method of the supercapacitor electrode material according to one embodiment of the present invention.

FIG. 4 is a graph showing the cycling life test results of the biomass porous carbon material produced by the manufacturing method of the supercapacitor electrode material according to one embodiment of the present invention.

### DETAILED DESCRIPTION OF THE PREFERRED EMBODIMENTS

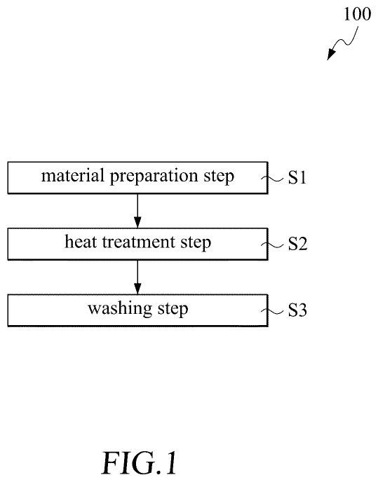

The preferred embodiments of the present invention are described in detail below according to FIGS. 1 to 4. The description is used for explaining the embodiments of the present invention only, but not for limiting the scope of the claims.

As shown in FIG. 1, according to one embodiment of the present invention, a manufacturing method of a supercapacitor electrode material 100 comprises a material preparation step S1 of mixing sodium ligninsulfonate, a surfactant and an activator to obtain a biomass material; a heat treatment step S2 of performing on the biomass material a heat treatment at 300° C. for 1 hour in an oxygen-free atmosphere, followed by a heat treatment at 900° C. for 8 hours in an oxygen-free atmosphere to obtain a carbonized material; and a washing step S3 of acid washing the carbonized material with hydrochloric acid to adjust pH to 0.5, followed by water washing to adjust the pH to above 6, thereby obtaining a biomass porous carbon material as the supercapacitor electrode material.

### Example 1

Sodium lignosulfonate and an anionic surfactant were mixed at a weight ratio of 1:2, along with 3 wt % calcium carbonate powder based on the mass of the sodium lignosulfonate, using a mechanical stirrer. The resulting mixture was then dried in an oven at 120° C. for 24 hours, and subjected to pyrolysis and carbonization by heating at a temperature of 350-450° C. The carbonized product was heated at 300° C. for 1 hour in an oxygen-free environment, followed by heating at 900° C. for 8 hours. The treated carbonized product was cooled to room temperature, and then ground with a pulverizer to obtain a powder. The powder was subjected to acid washing with hydrochloric acid until the pH value is less than 0.5, filtered, and then washed with deionized water to increase the pH value to above 6. After drying, the carbon powder was subjected to a second heat treatment in an oxygen-free environment by heating at 300° C. for 1 hour, followed by heating at 900° C. for 8 hours, thereby obtaining a biomass porous carbon material, designated as NS12-ds3.

### Example 2

Sodium lignosulfonate and an anionic surfactant were mixed at a weight ratio of 1:2, along with 5 wt % calcium carbonate powder based on the mass of the sodium lignosulfonate, using a mechanical stirrer. The resulting mixture was then dried in an oven at 120° C. for 24 hours, and subjected to pyrolysis and carbonization by heating at a temperature of 350-450° C. The carbonized product was heated at 300° C. for 1 hour in an oxygen-free environment, followed by heating at 900° C. for 8 hours. The treated carbonized product was cooled to room temperature, and then ground with a pulverizer to obtain a powder. The powder was subjected to acid washing with hydrochloric acid until the pH value is less than 0.5, filtered, and then washed with deionized water to increase the pH value to above 6. After drying, the carbon powder was subjected to a second heat treatment in an oxygen-free environment by heating at 300° C. for 1 hour, followed by heating at 900° C. for 8 hours, thereby obtaining a biomass porous carbon material, designated as NS12-ds5.

### Example 3

Sodium lignosulfonate and an anionic surfactant were mixed at a weight ratio of 1:2, along with 7 wt % calcium carbonate powder based on the mass of the sodium lignosulfonate, using a mechanical stirrer. The resulting mixture was then dried in an oven at 120° C. for 24 hours, and subjected to pyrolysis and carbonization by heating at a temperature of 350-450° C. The carbonized product was heated at 300° C. for 1 hour in an oxygen-free environment, followed by heating at 900° C. for 8 hours. The treated carbonized product was cooled to room temperature, and then ground with a pulverizer to obtain a powder. The powder was subjected to acid washing with hydrochloric acid until the pH value is less than 0.5, filtered, and then washed with deionized water to increase the pH value to above 6. After drying, the carbon powder was subjected to a second heat treatment in an oxygen-free environment by heating at 300° C. for 1 hour, followed by heating at 900° C. for 8 hours, thereby obtaining a biomass porous carbon material, designated as NS12-ds7.

### Example 4

Sodium lignosulfonate and an anionic surfactant were mixed at a weight ratio of 1:2, along with 10 wt % calcium carbonate powder based on the mass of the sodium lignosulfonate, using a mechanical stirrer. The resulting mixture was then dried in an oven at 120° C. for 24 hours, and subjected to pyrolysis and carbonization by heating at a temperature of 350-450° C. The carbonized product was heated at 300° C. for 1 hour in an oxygen-free environment, followed by heating at 900° C. for 8 hours. The treated carbonized product was cooled to room temperature, and then ground with a pulverizer to obtain a powder. The powder was subjected to acid washing with hydrochloric acid until the pH value is less than 0.5, filtered, and then washed with deionized water to increase the pH value to above 6. After drying, the carbon powder was subjected to a second heat treatment in an oxygen-free environment by heating at 300° C. for 1 hour, followed by heating at 900° C. for 8 hours, thereby obtaining a biomass porous carbon material, designated as NS12-ds10.

### Comparative Example 1

Sodium lignosulfonate and an anionic surfactant were mixed at a weight ratio of 1:2, using a mechanical stirrer. The resulting mixture was then dried in an oven at 120° C. for 24 hours, and subjected to pyrolysis and carbonization by heating at a temperature of 350-450° C. The carbonized product was heated at 300° C. for 1 hour in an oxygen-free environment, followed by heating at 900° C. for 8 hours. The treated carbonized product was cooled to room temperature, and then ground with a pulverizer to obtain a powder. The powder was subjected to acid washing with hydrochloric acid until the pH value is less than 0.5, filtered, and then washed with deionized water to increase the pH value to above 6. After drying, the carbon powder was subjected to a second heat treatment in an oxygen-free environment by heating at 300° C. for 1 hour, followed by heating at 900° C. for 8 hours, thereby obtaining a biomass porous carbon material, designated as NS12-ds0.

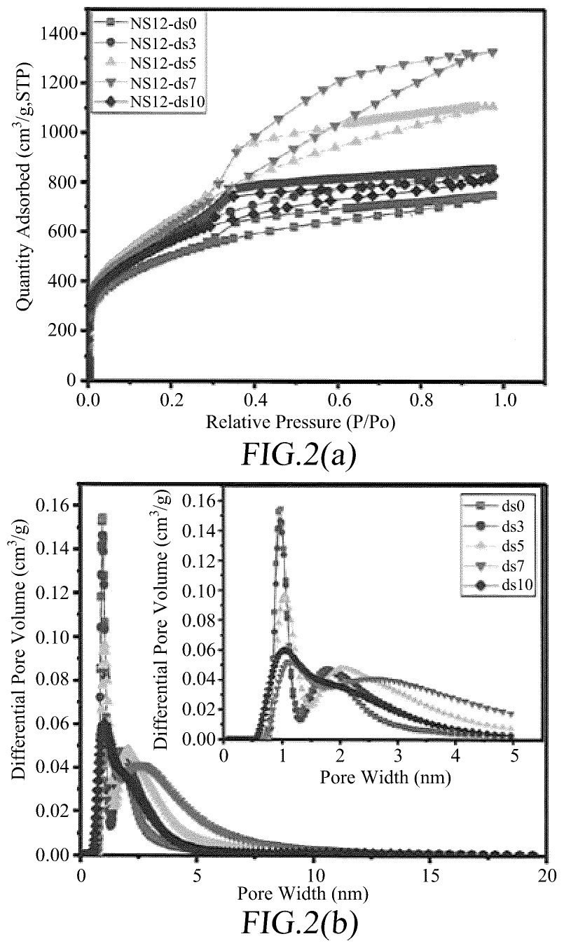

As shown in FIG. 2, NS12-ds0, NS12-ds3, NS12-ds5, NS12-ds7, and NS12-ds10 were subjected to nitrogen adsorption-desorption analysis, and the analysis results are summarized in Table 1.

TABLE 1

| | Sample | | | | |
|---|---|---|---|---|---|
| | NS12- | NS12- | NS12- | NS12- | NS12- |
| | ds0 | ds3 | ds5 | ds7 | ds10 |
| Specific | 1604 | 1781 | 2106 | 2148 | 1755 |
| surface area | | | | | |
| (m²/g) | | | | | |
| External | 1196 | 1611 | 2030 | 1985 | 1495 |
| surface area | | | | | |
| (m²/g) | | | | | |
| Micropores | 408 | 170 | 76 | 163 | 261 |
| (m²/g) | | | | | |
| Pore volume | 0.92 | 1.05 | 1.35 | 1.63 | 1.01 |
| (cm²/g) | | | | | |
| Pore diameter | 2.3 | 2.4 | 2.6 | 3.3 | 2.3 |
| (nm) | | | | | |

It can be seen from Table 1 that NS12-ds7 exhibits the highest specific surface area, and the pore diameter of the biomass porous carbon material produced by the manufacturing method of the present invention is approximately 2-3 nm.

The biomass porous carbon materials prepared according to the above examples and comparative examples were processed into electrode sheets and subjected to electrical performance testing.

NS12-ds0, NS12-ds3, NS12-ds5, NS12-ds7, and NS12-ds10 were each mixed with a conductive additive (Super P) and a binder (poly-methyl methacrylate; PMMA) at a weight ratio of 90:5:5, and then dispersed in ethyl acetate. The resulting slurry was subjected to vacuum filtration and uniformly coated onto a cellulose separator. The mass loading of the active material in the electrode was in the range of 1.0 to 1.2 mg/cm², excluding the weight of the separator. The electrodes were cut into circular disks with a diameter of 17 mm and vacuum-dried at 110° C. for 12 hours. Two prepared electrodes were placed face-to-face and assembled into a CR2032-type coin cell by bringing them into intimate contact with carbon-coated nickel foil via physical contact with a self-supporting carbon film. The entire assembly process was carried out in a glove box filled with hydrogen gas.

The assembled coin cells were subjected to charge-discharge testing at a constant current, with current densities of 0.1, 0.2, 0.5, 0.7, 1.0, 2.0, 5.0, 7.0, and 10.0 A/g, respectively.

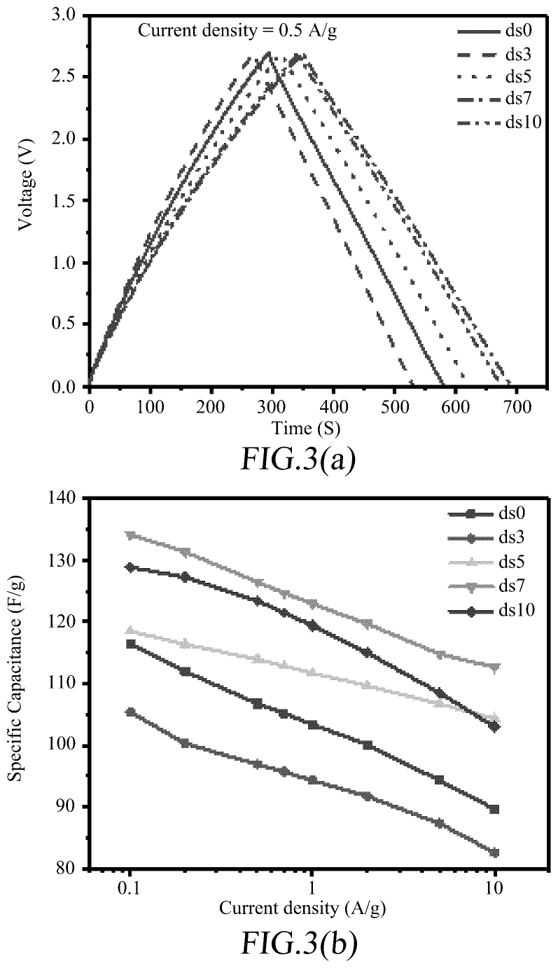

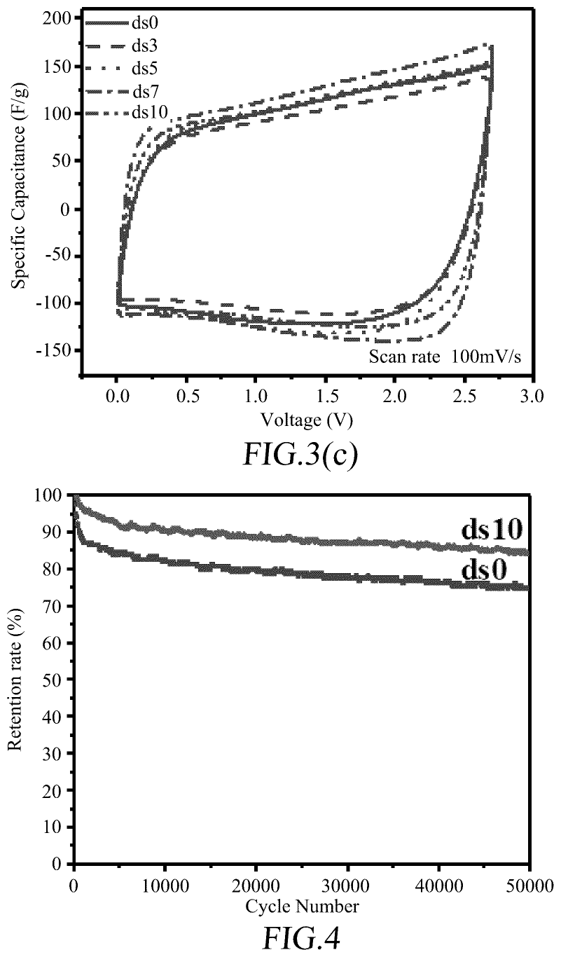

As shown in FIGS. 3(a), 3(b), 3(c), and 4, the coin cell fabricated using NS12-ds0 exhibited discharge capacitances of 116, 112, 107, 105, 103, 100, 94, 90, and 90 F/g corresponding to the respective current densities. The rate retention was 78%, with a maximum energy density of 29.1 Wh/kg and a maximum power density of 5.9 kW/kg. After 50,000 charge-discharge cycles at a constant current of 0.5 A/g within a potential window of 2.5 to 2.7 V, the capacitance retention was 75%.

The coin cell fabricated using NS12-ds3 exhibited discharge capacitances of 98, 94, 90, 88, 86, 82, 76, 73, and 72 F/g corresponding to the respective current densities, the rate retention of 75%, a maximum energy density of 24.4 Wh/kg and a maximum power density of 6.0 kW/kg.

The coin cell fabricated using NS12-ds5 exhibited discharge capacitances of 118, 116, 114, 113, 112, 110, 107, 107, and 104 F/g corresponding to the respective current densities the rate retention of 88%, a maximum energy density of 29.7 Wh/kg and a maximum power density of 5.9 kW/kg.

The coin cell fabricated using NS12-ds7 exhibited discharge capacitances of 134, 131, 126, 125, 123, 120, 115, 110, and 113 F/g, corresponding to the respective current densities the rate retention of 84%, a maximum energy density of 33.6 Wh/kg and a maximum power density of 6.1 kW/kg.

The coin cell fabricated using NS12-ds10 exhibited discharge capacitances of 129, 127, 123, 121, 119, 115, 109, 103, and 103 F/g, corresponding to the respective current densities the rate retention of 80%, a maximum energy density of 32.3 Wh/kg and a maximum power density of 6.1 kW/kg. After 50,000 charge-discharge cycles at a constant current of 0.5 A/g within a potential window of 2.5 to 2.7, the capacitance retention was 75%.

In another embodiment of the present invention, a manufacturing method is provided, wherein the carbonized material is crushed before the washing step S3.

In another embodiment of the present invention, a manufacturing method is provided further comprising, after the washing step S3, a second heat treatment step of performing on the biomass mixture a heat treatment at 300° C. for 1 hour in an oxygen-free atmosphere, followed by a heat treatment at 900° C. for 8 hours in an oxygen-free atmosphere.

In another embodiment of the present invention, a manufacturing method is provided, wherein in the material preparation step S1, the weight of the activator accounts for 1 to 15% of the weight of the sodium ligninsulfonate.

In another embodiment of the present invention, a manufacturing method is provided, wherein in the raw-material preparation step S1, the weight of the surfactant accounts for 50 to 200% of the total weight of the sodium ligninsulfonate and the activator.

In another embodiment of the present invention, a supercapacitor electrode is provided, wherein as an active material of the super capacitor electrode, the biomass porous carbon material prepared by the manufacturing method described above is used, as a conductive agent of the super capacitor electrode, at least one selected from the group consisting of carbon black, graphite, graphene, carbon nanotubes and carbon nanofibers is used, and as an adhesive of the supercapacitor electrode, at least one selected from the group consisting of methyl methacrylate, carboxymethyl cellulose, styrene-butadiene rubber and polyvinylidene fluoride is used.

In another embodiment of the present invention, a supercapacitor electrode is provided, wherein the weight of the conductive agent accounts for 1 to 10% of the weight of the active material.

In another embodiment of the present invention, a supercapacitor electrode is provided, wherein the weight of the adhesive accounts for 1 to 10% of the weight of the active material.

By means of the technical means adopted by the manufacturing method of the supercapacitor electrode material described above, commercial-grade biomass porous carbon material can be produced from sodium lignosulfonate, a by-product generated from the pulping process, for use in fabricating supercapacitor electrodes, thereby reducing the cost of supercapacitor electrodes, enhancing the economic value of biomass waste, and achieving the trend of circular economy.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A manufacturing method of a supercapacitor electrode material, comprising:
a material preparation step of mixing sodium ligninsulfonate, a surfactant and an activator to obtain a biomass material;
a heat treatment step of performing on the biomass material a heat treatment at 300° C. for 1 hour in an oxygen-free atmosphere, followed by a heat treatment at 900° C. for 8 hours in an oxygen-free atmosphere to obtain a carbonized material; and
a washing step of acid washing the carbonized material with hydrochloric acid to adjust pH to 0.5, followed by water washing to adjust the pH to above 6, thereby obtaining a biomass porous carbon material as the supercapacitor electrode material.

2. The manufacturing method as claimed in claim 1, further comprising, before the washing step, a crushing step of crushing the carbonized material.

3. The manufacturing method as claimed in claim 1, further comprising, after the washing step, a second heat treatment step of performing on the biomass mixture a heat treatment at 300° C. for 1 hour in an oxygen-free atmosphere, followed by a heat treatment at 900° C. for 8 hours in an oxygen-free atmosphere.

4. The manufacturing method as claimed in claim 1, wherein in the material preparation step, the weight of the activator accounts for 1 to 15% of the weight of the sodium ligninsulfonate.

5. The manufacturing method as claimed in claim 1, wherein in the raw-material preparation step, the weight of the surfactant accounts for 50 to 200% of the total weight of the sodium ligninsulfonate and the activator.

6. A supercapacitor electrode, wherein:
as an active material of the super capacitor electrode, the biomass porous carbon material prepared by the manufacturing method as claimed in claim 1 is used,
as a conductive agent of the super capacitor electrode, at least one selected from the group consisting of carbon black, graphite, graphene, carbon nanotubes and carbon nanofibers is used, and
as an adhesive of the supercapacitor electrode, at least one selected from the group consisting of methyl methacrylate, carboxymethyl cellulose, styrene-butadiene rubber and polyvinylidene fluoride is used.

7. The supercapacitor electrode as claimed in claim 6, wherein the weight of the conductive agent accounts for 1 to 10% of the weight of the active material.

8. The supercapacitor electrode as claimed in claim 6, wherein the weight of the adhesive accounts for 1 to 10% of the weight of the active material.

9. A supercapacitor electrode, wherein:
as an active material of the super capacitor electrode, the biomass porous carbon material prepared by the manufacturing method as claimed in claim 2 is used,
as a conductive agent of the super capacitor electrode, at least one selected from the group consisting of carbon black, graphite, graphene, carbon nanotubes and carbon nanofibers is used, and
as an adhesive of the supercapacitor electrode, at least one selected from the group consisting of methyl methacrylate, carboxymethyl cellulose, styrene-butadiene rubber and polyvinylidene fluoride is used.

10. The supercapacitor electrode as claimed in claim 9, wherein the weight of the conductive agent accounts for 1 to 10% of the weight of the active material.

11. The supercapacitor electrode as claimed in claim 9, wherein the weight of the adhesive accounts for 1 to 10% of the weight of the active material.

12. A supercapacitor electrode, wherein:
as an active material of the super capacitor electrode, the biomass porous carbon material prepared by the manufacturing method as claimed in claim 3 is used,
as a conductive agent of the super capacitor electrode, at least one selected from the group consisting of carbon black, graphite, graphene, carbon nanotubes and carbon nanofibers is used, and
as an adhesive of the supercapacitor electrode, at least one selected from the group consisting of methyl methacrylate, carboxymethyl cellulose, styrene-butadiene rubber and polyvinylidene fluoride is used.

13. The supercapacitor electrode as claimed in claim 12, wherein the weight of the conductive agent accounts for 1 to 10% of the weight of the active material.

14. The supercapacitor electrode as claimed in claim 12, wherein the weight of the adhesive accounts for 1 to 10% of the weight of the active material.

15. A supercapacitor electrode, wherein:
as an active material of the super capacitor electrode, the biomass porous carbon material prepared by the manufacturing method as claimed in claim 4 is used,
as a conductive agent of the super capacitor electrode, at least one selected from the group consisting of carbon black, graphite, graphene, carbon nanotubes and carbon nanofibers is used, and
as an adhesive of the supercapacitor electrode, at least one selected from the group consisting of methyl methacrylate, carboxymethyl cellulose, styrene-butadiene rubber and polyvinylidene fluoride is used.

16. The supercapacitor electrode as claimed in claim 15, wherein the weight of the conductive agent accounts for 1 to 10% of the weight of the active material.

17. The supercapacitor electrode as claimed in claim 15, wherein the weight of the adhesive accounts for 1 to 10% of the weight of the active material.

18. A supercapacitor electrode, wherein:
as an active material of the super capacitor electrode, the biomass porous carbon material prepared by the manufacturing method as claimed in claim 5 is used,
as a conductive agent of the super capacitor electrode, at least one selected from the group consisting of carbon black, graphite, graphene, carbon nanotubes and carbon nanofibers is used, and
as an adhesive of the supercapacitor electrode, at least one selected from the group consisting of methyl methacrylate, carboxymethyl cellulose, styrene-butadiene rubber and polyvinylidene fluoride is used.

19. The supercapacitor electrode as claimed in claim 18, wherein the weight of the conductive agent accounts for 1 to 10% of the weight of the active material.

20. The supercapacitor electrode as claimed in claim 18, wherein the weight of the adhesive accounts for 1 to 10% of the weight of the active material.
